(19) United States
(12) Patent Application Publication
(10) Pub. No.: US 2007/0154639 A1
(43) Pub. Date: Jul. 5, 2007

(54) Coated articles and methods of manufacture thereof

(76) Inventors: Kinga A. Malinger, Paris (FR); Laura Espinal, Willington, CT (US); Steven L. Suib, Storrs, CT (US); Lawrence L. Murrell, South Plainfield, NJ (US); Anais E. Espinal, Willington, CT (US)

Correspondence Address: CANTOR COLBURN, LLP, 55 GRIFFIN ROAD SOUTH, BLOOMFIELD, CT, 06002, US

(21) Appl. No.: 11/592,655

(22) Filed: Nov. 3, 2006

Related U.S. Application Data
(60) Provisional application No. 60/733,222, filed on Nov. 3, 2005.

(51) Int. Cl. B05D 3/00; B05D 5/00; B05D 3/02; B05D 7/00; B29C 71/04

(52) U.S. Cl. 427/256; 427/532; 427/429; 427/421.1; 427/372.2

(57) ABSTRACT

A method for coating articles includes contacting a substrate with a mixture comprising a coating composition and a carrier fluid effective to wet at least a portion of the substrate, and removing the carrier fluid by microwave heating for a time and at a temperature effective to produce a coating comprising the coating composition on at least a portion of substrate. The coated articles may be useful in a variety of applications including ion, molecule, and gas separation/filtration; ion-exchanging; semiconductors; catalysis; and as electrodes, among others.

### CROSS REFERENCE TO RELATED APPLICATIONS

The present application claims the benefit of U.S. Provisional Patent Application No. 60/733,222, which was filed on Nov. 3, 2005, and is herein incorporated by reference in its entirety.

### STATEMENT REGARDING FEDERALLY SPONSORED RESEARCH

The United States Government has certain rights in this invention pursuant to National Science Foundation Grant No. 0304217.

### BACKGROUND

Coatings play a prominent role in the manufacture and performance of many devices. They are used to tailor the surfaces of a substrate, for example, to provide a different appearance (e.g., color, shape, and/or dimension), control friction and wear, inhibit corrosion, and/or change a physical property (e.g., adsorption, conductivity, or the like) of a substrate. A variety of techniques have been developed to provide coated articles.

Two frequently used methods of applying coatings to a substrate include dipping a substrate into, or spraying a substrate with, a solid-liquid mixture containing the coating material, followed by removal of the liquid. Unfortunately, it may be difficult, using these techniques, to produce uniform coatings in which the thickness of the coating at the corners or edges of a three-dimensional substrate is substantially the same as the coating thickness at other portions of the substrate. This problem is exacerbated when the substrate is textured and/or porous. The non-uniformity in the coating arises primarily during removal of the liquid, which has been sprayed on the substrate or into which the substrate has been dipped.

To overcome the difficulties in obtaining uniform coatings on three-dimensional substrates, liquidless techniques have been developed. For example, powder coating is based on dipping a substrate into a bed of an electrostatically charged powder, or on spraying an electrostatically charged powder onto the substrate. While these methods may produce more uniform coatings, additional complexities (e.g., extensive substrate surface and/or coating powder preparation steps) may be introduced that do not exist for processes using liquids.

There accordingly remains a need in the art for new methods of preparing coated articles. It would be particularly advantageous if these methods provided the desired uniform coatings on three-dimensional substrates, such as those associated with powder coating, without simultaneously requiring additional and/or more complex processing steps.

### SUMMARY

A method for coating articles includes contacting a substrate with a mixture comprising a coating composition and a carrier fluid effective to wet at least a portion of the substrate, and removing the carrier fluid by microwave heating for a time and at a temperature effective to produce a coating comprising the coating composition on at least a portion of substrate.

In another embodiment, the method includes contacting a three-dimensional network of fibers with a mixture comprising an oxide composition and a carrier fluid effective to wet at least a portion of the fibers and removing the carrier fluid by microwave heating for a time and at a temperature effective to produce an oxide coating on at least a portion of the fibers.

Other embodiments include coated articles made by above methods.

The above described and other features are exemplified by the following figures and detailed description.

### BRIEF DESCRIPTION OF THE DRAWINGS

Referring now to the Figures, which are exemplary embodiments, and wherein the like elements are numbered alike:

FIG. 1 is a representative color photographic image of a convection dried sample of quartz-like fibers within a non-woven paper which was dipped in a 30 weight percent (wt %) suspension of silica;

FIG. 2 is a representative color photographic image of a microwave dried sample of quartz-like fibers within a non-woven paper which was dipped in a 30 wt % suspension of silica;

FIG. 3 illustrates representative scanning electron micrographs of coatings produced from microwave drying of fibers within a non-woven paper which have been dipped in a 5 wt % silica colloidal suspension, shown at (a) 3,000 and (b) 10,000 times magnification;

FIG. 4 illustrates representative scanning electron micrographs of coatings produced from microwave drying of fibers within a non-woven paper which have been dipped in a 10 wt % silica colloidal suspension, shown at (a) and (b) 5,000 times magnification;

FIG. 5 illustrates representative scanning electron micrographs of coatings produced from microwave drying of fibers within a non-woven paper that have been dipped in a 20 wt % silica colloidal suspension, shown at (a) 3,000 and (b) 5,000 times magnification;

FIG. 6 illustrates representative scanning electron micrographs of coatings produced from microwave drying of (using a variable frequency microwave furnace) of fibers within a non-woven paper that have been dipped in a 20 wt % silica colloidal suspension, shown at (a) and (b) 5,000 times magnification;

FIG. 7 illustrates representative scanning electron micrographs of coatings resulting from sequentially microwave drying of fibers within a non-woven paper that have been dipped in a 5% silica colloidal suspension, shown at (a) 10,000, (b) 10,000, (c) 5,000, and (d) 5,000 times magnification;

FIG. 8 illustrates representative scanning electron micrographs of coatings produced from microwave drying of fibers within a non-woven paper that have been dipped in a 10 wt % alumina colloidal suspension, shown at (a) 3,000 and (b) 10,000 times magnification;

FIG. 9 illustrates representative scanning electron micrographs of coatings produced from microwave drying of fibers within a non-woven paper that have been dipped in a 10 wt % ceria colloidal suspension, shown at (a) 5,000 and (b) 50,000 times magnification;

FIG. 10 illustrates representative scanning electron micrographs of coatings produced from microwave drying of fibers within a non-woven paper that have been dipped in a 10 wt % zirconia colloidal suspension, shown at (a) 3,000 and (b) 5,000 times magnification;

FIG. 11 illustrates representative optical images of coatings produced by (a) room temperature evaporating, (b) convection heating, and (c) microwave heating of fibers within a non-woven paper that have been dipped in a suspension having 9.5 wt % activated charcoal and 0.5 wt % silica; and

FIG. 12 illustrates representative scanning electron micrographs of (a) an uncoated quartz-like fiber within a non-woven paper, and coatings produced by (b) room temperature evaporating, (c) convection heating, and (d) microwave heating of fibers within a non-woven paper that have been dipped in a suspension having 9.5 wt % activated charcoal and 0.5 wt % silica.

### DETAILED DESCRIPTION

Disclosed herein are methods of manufacturing coated articles. The methods generally comprise contacting a substrate with a mixture comprising a coating composition and a carrier fluid effective to wet at least a portion of the substrate, and removing the carrier fluid by microwave heating for a time and at a temperature effective to produce a coating comprising the coating composition on at least the portion of substrate. In an advantageous feature, the coated articles produced by the methods disclosed herein can have uniform coatings in which the thickness of the coating at the corners or edges of the substrate is substantially the same as the coating thickness at other portions of the substrate.

The term “wet” is used herein in its broadest sense to indicate any maintained contact between the mixture and any surface of the substrate, and includes discrete beading of the mixture on portions of the substrate's surface as well as a continuous film of the mixture distributed over the surface of the substrate. The term “substrate” is used herein for convenience to generally refer to the article having the coating disposed thereon, and includes materials having irregular shapes such as flakes, fibers (woven or non-woven), honeycomb materials, as well as regular shapes such as for example monoliths, spheres, and films.

Also as used herein, the terms “first,” “second,” and the like do not denote any order or importance, but rather are used to distinguish one element from another, and the terms “the”, “a” and “an” do not denote a limitation of quantity, but rather denote the presence of at least one of the referenced item. Furthermore, all ranges reciting the same quantity or physical property are inclusive of the recited endpoints and independently combinable. The modifier “about” used in connection with a quantity is inclusive of the stated value and has the meaning dictated by the context or includes the degree of error associated with measurement of the particular quantity.

The mixture comprising the coating composition and the carrier fluid may be a suspension (e.g., an emulsion, dispersion, slurry, or the like), colloid (e.g., fine particle containing suspensions, sols, or the like), or a solution, or a combination comprising at least one of the foregoing.

Any composition may be used for the coating composition, provided that it is in solid form within the above-described mixture. Suitable coating compositions include a metal, an alloy, an oxide, a carbide, a form of carbon, a nitride, a boride, a composite comprising at least one of the foregoing, or a combination comprising at least one of the foregoing. Exemplary oxides include Al₂O₃, CeO₂, Cr₂O₃, ZrO₂, SiO₂, Y₂O₃, La₂O₃, TiO₂, SnO₂, and the like, and combinations comprising at least one of the foregoing. Exemplary carbides include Cr₃C₂, WC, TiC, ZrC, SiC, B₄C, and the like, and combinations comprising at least one of the foregoing. Exemplary forms of carbon include graphite, diamond, charcoal, activated charcoal, carbon black, and the like, and combinations comprising at least one of the foregoing. Exemplary nitrides include BN, TiN, ZrN, HfN, Si₃N₄, AlN, and the like, and combinations comprising at least one of the foregoing. Exemplary borides include TiB₂, ZrB₂, LaB, LaB₆, W₂B₂, and the like, and combinations comprising at least one of the foregoing.

When the mixture is a suspension, an average longest dimension of a coating composition particle is greater than about 1 micrometer (μm). Desirably, the average longest dimension of the coating composition particle in a suspension is less than about 6 μm. When the mixture is a colloid, the average longest dimension of a coating composition particle is greater than or equal to about 1 nanometer (nm) and less then or equal to about 1 μm. If the mixture is a solution, then the coating composition will be at least partially dissolved in the carrier liquid with no restriction on the particle size of any particles not dissolved.

The carrier fluid used in the mixture may comprise any aqueous or organic compound, or mixture thereof, that is a liquid at the contacting temperature, provided that this fluid does not adversely affect the coating composition and/or the substrate. Suitable carrier fluids include water, such as deionized water (DI—H₂O), distilled water, or deionized distilled water (DDW); acids, such as nitric acid, acetic acid, sulfuric acid, phosphoric acid, hydrofluoric acid, and the like; bases, such as hydroxides of Na, K, NH₄, and the like; alcohols; polyols; ketones; and the like; and a combination comprising at least one of the foregoing.

The mixture may further contain other components known in the art. For example, the mixture may comprise stabilizers, pH regulators, viscosity modifiers, wetting agents, water soluble polymers, and/or other chemical agents that may promote wetting of the substrate, inhibit settling of the coating composition within the mixture and/or aid in attachment of the coating to the substrate.

In an exemplary embodiment, the mixture is a colloid comprising oxide particles having an average longest dimension of about 1 nm to about 0.6 μm in water and/or ethylene glycol. In another exemplary embodiment, the mixture comprises dry or wet milled particles mixed with a colloid, which serves as a binder for the milled particles to bind to the surface of the substrate.

The substrate may be any solid material with a surface on which the coating will deposit, provided that the substrate is not adversely affected by the microwaves and/or any of the mixture components. Suitable substrates include metals, alloys, ceramics, glass, organic polymers, fluorinated polymers, quartz, sapphire, wood, paper, carbon, and the like. Suitable metals include transition group metals, rare earth metals including lanthanides and actinides, alkali metals, alkaline earth metals, main group metals, and combinations comprising at least one of the foregoing metals. Suitable ceramics include the oxides, carbides, nitrides and borides described above, as well as aluminosilicates, clays, and the like. Suitable fluorinated polymers include tetrafluoroethylene (TFE), poly(tetrafluoroethylene) (PTFE), fluoroethylene-propylene (FEP), and the like.

As stated above, the substrate is not intended to be limited to a particular size, shape, and/or texture. The size, shape and/or texture of the substrate do not appear to be critical to the ability of the coating to be formed.

In a specific embodiment, the substrate is a ceramic honeycomb structure. In another specific embodiment, the substrate is a three-dimensional network of fibers within a non-woven paper, wherein the fibers have an average diameter of about 5 to about 15 μm, and an average basis weight of about 18 to about 300 grams per square meter (gsm). The fibers within the paper may have an ordered orientation or may be randomly oriented with respect to each other. The three-dimensional network of fibers may be held intact by a polymeric binder positioned at the intersections of the fibers. Exemplary fiber materials include silica (e.g., quartz) fibers, or silica-like (e.g., quartz-like) fibers, carbon fibers, and the like.

The mixture may be contacted with the substrate in various ways. These include dipping or immersing the substrate in the mixture, spraying the substrate with the mixture, brushing the substrate with the mixture, pouring the mixture on the substrate, paste casting, inkjetting the mixture towards the substrate, or the like, or a combination comprising at least one of the foregoing. The particular method of contacting the substrate with the mixture will be selected based on the properties of the substrate and/or the concentration of the coating composition within the mixture. For example, for a highly porous substrate, it may be advantageous to immerse the substrate in the mixture and/or pour the mixture on the substrate to maximize the amount of the overall surface area of the substrate that the mixture can contact. Alternatively, if only a portion of the substrate is to be coated, spraying, brushing, paste casting, and/or inkjetting the portion of the substrate with the mixture may be most desirable.

Once the substrate has been sufficiently wetted with the mixture, it may be desirable to remove excess carrier fluid from the substrate. This can be performed by simply allowing the force of gravity to act on the carrier fluid, agitating (e.g., shaking) the wetted substrate, flowing a gas (e.g., air) over the wetted substrate, contacting the wetted substrate with an adsorbent material (e.g., sponge, towel, tissue, and the like), or the like, or a combination comprising at least one of the foregoing. Without being bound by theory, it is believed that performing this optional step minimizes the opportunity for so-called build up of the coating composition at a specific location on the surface of the substrate to occur, and thereby increases the likelihood that a more uniform distribution of the coating composition over the entire substrate can be achieved.

After the contacting step or optional excess carrier fluid removal step, the wetted substrate is exposed to microwave irradiation so that the remainder of the carrier fluid can be removed and the coating can be formed.

The microwave heating process can be performed with different types of microwave systems, all of which can effectively localize microwave power. A microwave system generally comprises a sample chamber in communication with a microwave source. One type of microwave system is a single pass, traveling wave applicator, where microwave energy propagates down the length of a waveguide, where the maximum field and power is concentrated at the center of the waveguide where the sample is located. A second type of system is a standing wave system where the microwaves are introduced into a tuned chamber, which concentrates the microwave energy at the location of the sample. A third system is a beam system, where microwave energy is focused directly onto the sample. Suitable microwave sources include, but are not limited to, a magnetron and a gyrotron.

Suitable frequencies include, but are not limited to about 1 gigaHertz (GHz) to about 7 GHz. Suitable microwave powers may be up to, but not limited to, about 1300 Watts (W). The microwave heating process may be carried out at any temperature provided that the temperature does not adversely affect (e.g., melt, decompose, or the like) the substrate and/or mixture, and does not cause a side reaction between the substrate and any of the components of the mixture. Suitable temperatures may be about 30 degrees Celsius (° C.) to about 600° C. The duration of the microwave heating will depend upon several factors including the microwave energy and frequency, as well as the carrier fluid to be removed. In one embodiment, microwaving can be performed for a time of about 1 minute to about 6 hours. More specifically, microwave heating can be performed for about 10 minutes to about 1 hour.

Without being bound by theory, in conventional heating methods, relying solely on convection, thermal energy is absorbed on the surface of an object to be heated and then is transferred towards the interior of the object via thermal conductivity. Because energy transfer is occurring that is localized at the surface, the process can be quite slow. With microwave heating, owing to deep penetration by the microwaves, energy is absorbed by the object to be heated as a whole and then converted to heat via dielectric loss mechanisms and/or eddy current losses (if the object is electrically conductive). Because there is effective energy conversion, the process can be quite rapid. Furthermore, with microwave irradiation, the heating is more uniform and less localized, which, with respect to removing the carrier fluid, results in decreased migration of the coating composition during the drying process. This, in turn, results in coatings that may be more uniform and have fewer or no bare spots.

In an exemplary embodiment, the microwave heating is performed while the wetted substrate is in a fluid bed chamber or an expanded bed chamber. For example, microfiber particles can be formed from a three-dimensional network of fiber paper that has been shaped to the desired size, such as by water jet cutting, laser cutting, die cast cutting, or the like. Desirably, the particles are shaped to be spherical or substantially spherical, with a narrow distribution of the particle size, to achieve the appropriate volume expansion conditions. In a fluidized bed, the particles may have an average diameter of about 30 μm to about 1 millimeter (mm); while, in an expanded bed, the particles may have an average diameter of about 10 μm to about 5 mm. A plurality of microfiber particles can be placed in a fluid bed or expanded bed chamber and contacted with the mixture comprising the coating composition by flowing the mixture through the chamber, or can be contacted with the mixture comprising the coating composition as described above and subsequently placed in the fluid bed or expanded bed chamber. Once the plurality of wetted microfiber particles has been disposed in the fluid bed or expanded bed chamber, the microwave heating step can be performed while a gas flows through the bed to achieve the desired volume expansion. The gas can be a reducing or oxidizing gas if the desired final coating composition is slightly different than what is included in the mixture, or the gas can be an inert gas. Further, the gas can be heated or dried to facilitate removing the carrier fluid of the mixture from the substrate.

In one embodiment, both microwave heating and thermal heating can be used to remove the carrier fluid. In this manner, the overall heating time can be reduced. The thermal heating may be achieved by contacting the wetted substrate with a heated gas while it is contained inside the microwave system. The particular gas may have any composition provided that the gas is not involved in a side reaction with the substrate, any of the components of the mixture, and/or the microwave irradiation. Exemplary gases include air, nitrogen, any of the inert gases, or the like. Desirably, the gas is introduced into the microwave system with a sufficiently low pressure so as to prevent coating composition particles from being removed from the substrate.

Once the coating has been formed, the coating may undergo an optional sintering, annealing, or calcining step (depending on the particular composition of coating that has been formed). These microstructure altering or developing heat treatments can be performed in any environment (e.g., air, hydrogen, nitrogen, oxygen, or the like), the temperature and duration of which are dependent on the particular composition and extent of microstructure alteration or development necessary.

The thickness of the coating may be controlled by the dimension of the substrate, the extent of the contacting, and/or the concentration of the coating composition in the mixture. The average thickness of the coating may be about 10 nm to about 1 millimeter (mm).

As previously mentioned, the coatings produced by the methods disclosed herein may be more uniform than those of the prior art. For example, it is possible to produce coatings which have less than or equal to about 10% deviation in thickness over essentially the entire coating. It is also possible to produce coatings that have less than or equal to about 5% deviation in thickness over essentially the entire coating.

Those skilled in the art in view of this disclosure should recognize that multiple, sequential coatings can advantageously be deposited onto a single substrate by simply repeating the coating process using the same or a different coating composition. If the same coating composition is used, then repeating the coating process serves to control (by increasing) the thickness of the coating. However, if a different coating composition is used, then repeating the coating process results in a layered article. In certain cases it may be useful to perform a microstructure altering or developing heat treatment on the coating after one or more of the coating and microwave treatment steps at a high temperature in order to obtain the most uniform final coated structure. For example, in one embodiment, a first coating composition can be deposited and may serve as a support for a second coating composition which may be a catalytically active material. In this manner, a heterogeneous catalyst can be formed on a substrate having a selected shape or structure for a desired application. In another embodiment, the second coating composition can be selectively deposited on only a portion of the coated substrate by simply contacting only that portion of the coated substrate with the second mixture. For example, a uniform coating within a fiber substrate could be deposited, and then a subsequent coating could be deposited only at the surface of the fiber substrate.

The coatings and coated articles are useful in a variety of applications including, but not limited to, ion, molecule, and gas separation/filtration; ion-exchanging; semiconductors; catalysis; and as electrodes, among others.

The disclosure is further illustrated by the following non-limiting examples.

### EXAMPLE 1

### Comparison Between Convection and Microwave Dried Silica Coated Quartz-like Fiber Paper

Quartz-like fiber non-woven paper (obtained under the trade name CRANEGLAS 500), having a thickness of about ⅛ inch and a weight of about 0.1 grams (g) was used as the substrate. Postage stamp sized pieces of the quartz-like non-woven fiber paper were independently dipped into a 20 weight percent (wt %) and 30 wt % colloidal suspension of silica (LUDOX), based on the total weight of the suspension. Subsequently, the samples were contacted with tissue paper and/or a glass surface to remove any excess liquid. The weight of the samples after removing the excess liquid was about 1.2 g.

One sample of each type (i.e., those dipped in the 20 wt % suspension and those dipped in the 30 wt % suspension) was placed vertically in separate Pyrex beakers, which were inserted into a convection furnace. The samples were dried for about 1 hour at about 120° C.

Alternatively, one sample of each type was placed in separate Teflon containers, which were inserted into a constant frequency microwave furnace operating at about 2.45 GHz. The samples were dried for about 30 minutes at about 120° C.

Finally, all samples were calcined at about 600° C. for about 6 hours. The final weight of the samples was about 0.4 g.

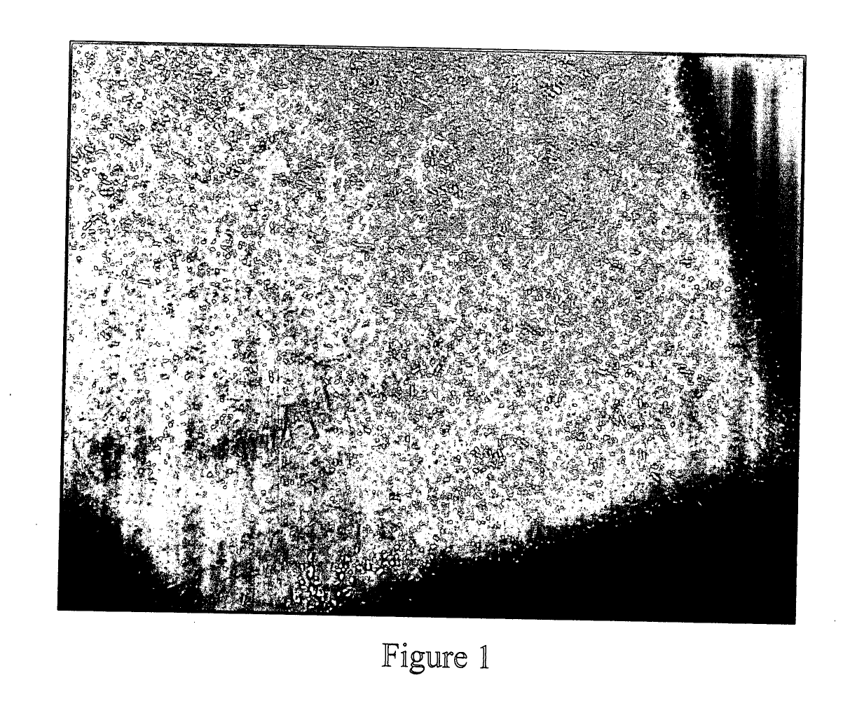

The convection dried samples had uneven distribution of the oxide on the quartz fibers. Specifically, a majority of the SiO₂ was found on the outside edges or surfaces of the paper, while, in some regions, there was no coating whatsoever. In addition, some of the SiO₂ did not coat the fibers, but instead was observed to be held in place between various fibers. FIG. 1, which is a representative photographic image of a convection dried quartz fiber sample dipped in the 30 wt % suspension, clearly illustrates these characteristics.

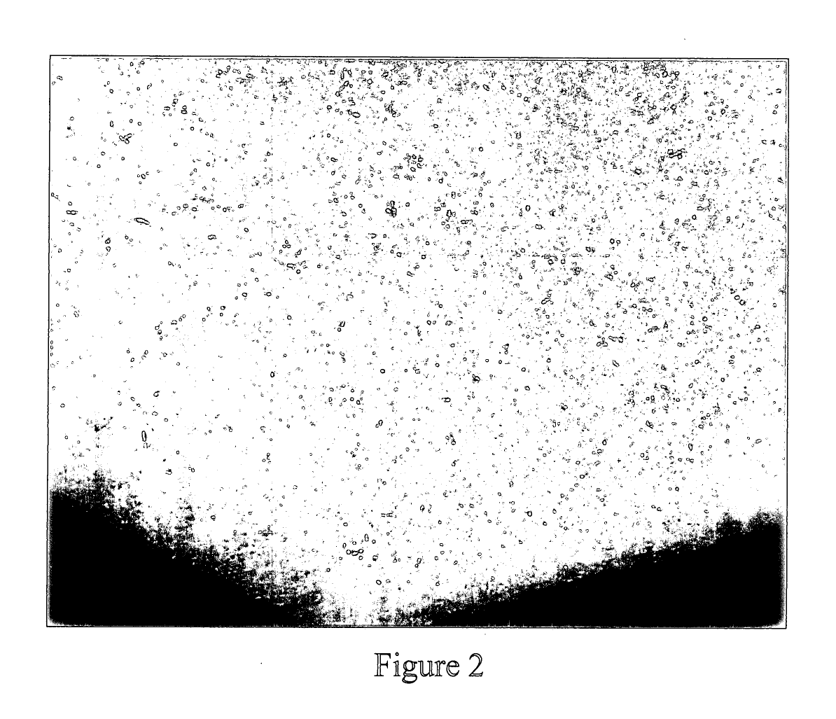

In stark contrast, a substantially uniform coating was observed throughout the paper for the microwave dried samples. A representative photographic image of a microwave dried quartz fiber sample dipped in the 30 wt % suspension is shown in FIG. 2. As evidenced, the SiO₂ coating showed no preference for the edges of the paper.

### EXAMPLE 2

### Quartz-like Fiber Paper Dipped in Silica Suspensions of Varying Concentrations

In this example, the effect of using silica suspensions having different concentrations of SiO₂ therein was studied. Microwave dried samples of quartz-like fiber papers dipped in silica suspensions were prepared according to Example 1, except that the fiber paper was about 1/16 inch thick. The concentration levels of silica in suspension used were 5 wt %, 10 wt %, and 20 wt %.

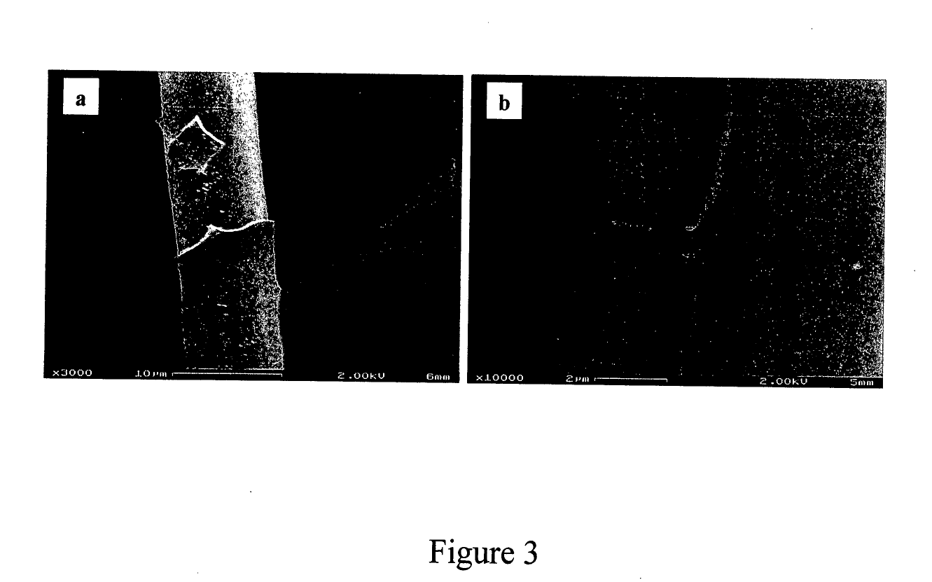

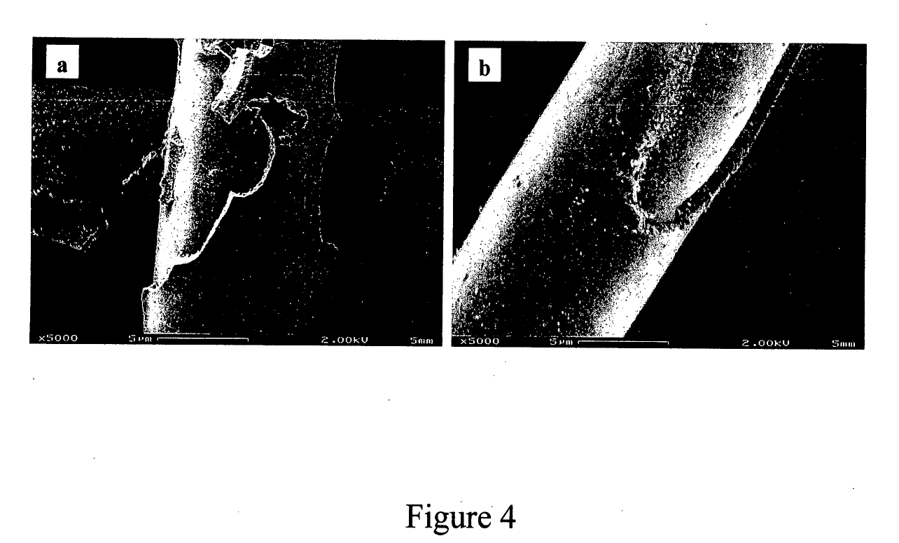

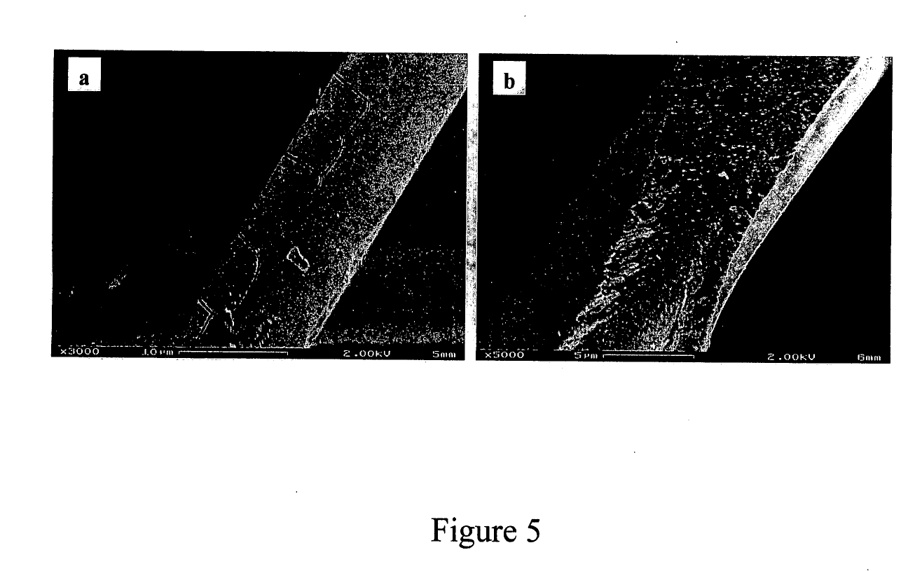

High resolution field emission scanning electron microscopy (SEM) indicated that the thickness of the individually coated fibers increased with the concentration of SiO₂ in the suspension. FIGS. 3 through 5 are representative SEM images of coatings resulting from microwave drying of fibers dipped in the 5 wt %, 10 wt %, and 20 wt % SiO₂ suspensions, respectively. The coating fractures shown in the micrographs throughout this disclosure are a result of mechanical processing of the sample during preparation for microscopy. However, from these fractures, it is possible to measure the thickness of the coating deposited on the particular fiber shown in each micrograph. For example, in the SEM image shown in FIGS. 3 (b), 4 (b), and 5 (b), the thickness of the coating deposited on the fibers shown are about 500 nanometers (nm), about 1 micrometer (μm), and about 1.25 μm, respectively.

### EXAMPLE 3

### Variable Frequency Microwave Furnace Dried Silica Coated Quartz-like Fiber Paper

In this example, samples were prepared according to Example 1, except that a variable frequency microwave furnace was used to dry the samples. A center frequency of about 4 GHz was used while varying the power from about 33 to about 99 W with a sweep time of about 10 seconds (s) to heat the samples at about 120° C. for about 30 minutes.

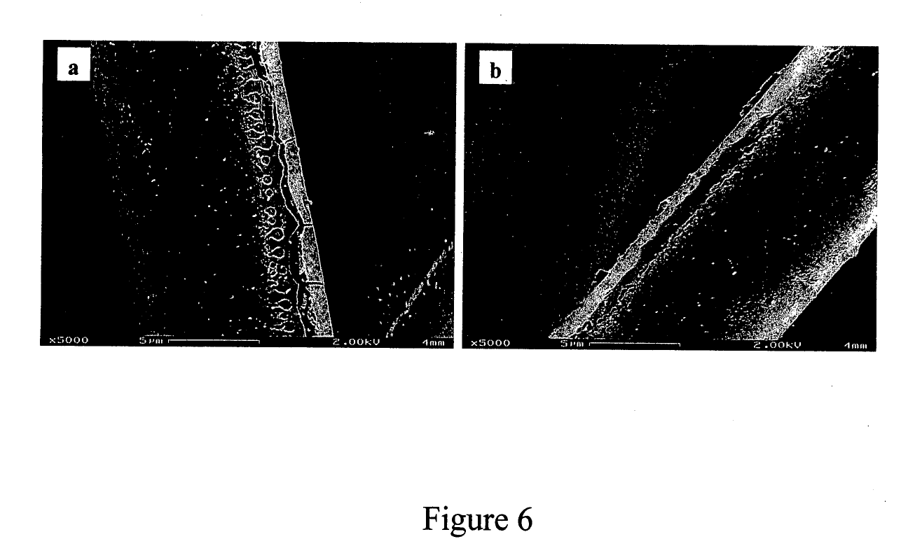

Similar to those coatings obtained using a continuous frequency microwave furnace, the coatings obtained using a variably frequency microwave furnace were substantially uniform and markedly superior to those obtained using a convection furnace. FIG. 6 illustrates representative SEM images of coatings resulting from microwave drying (using a variable frequency microwave furnace) fiber papers dipped in a 20 wt % SiO₂ suspension.

### EXAMPLE 4

### Sequential Coating of Quartz-like Fiber Paper

In this example, samples were sequentially coated by repeating the procedure described in Example 1 (i.e., dipping, removing excess liquid, microwave drying, and calcining) for a particular piece of quartz-like fiber paper. Each repetition of this procedure resulted in a coating of increased thickness.

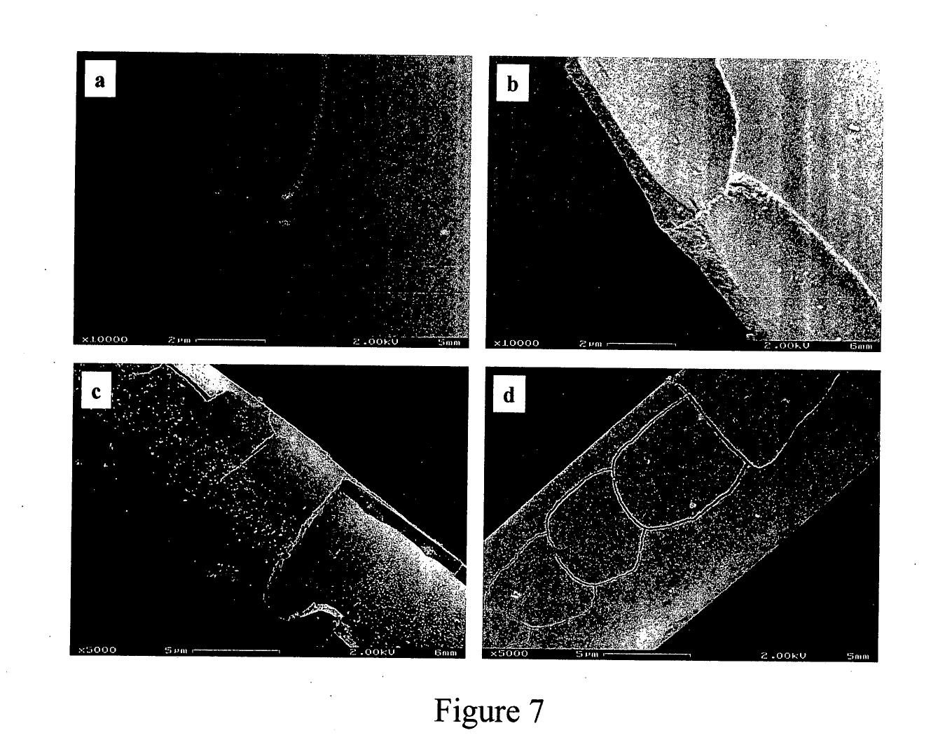

FIG. 7 (a) is a representative SEM image showing a coating resulting from microwave drying (using a constant frequency microwave furnace) a sample dipped in a 5 wt % SiO₂ suspension. FIGS. 7 (b)-(d), respectively, illustrate representative SEM images of coatings resulting from first, second, and third repetitions of the procedure described in Example 1.

### EXAMPLE 5

### Alumina Coated Quartz-like Fiber Paper

In this example, samples were prepared according to Example 1, except that a 10 wt % colloidal suspension of alumina (NYACOL AL20DW) was used to produce Al₂O₃ coated quartz-like fiber paper samples.

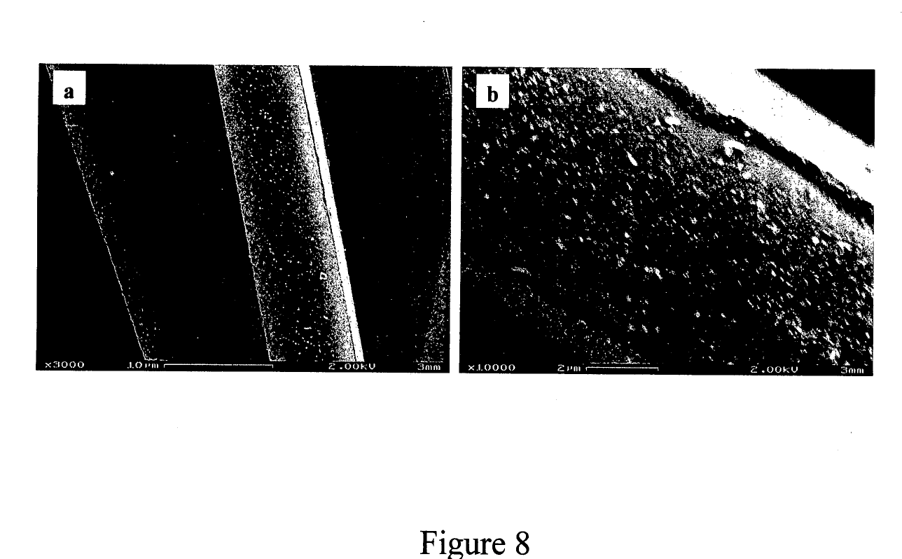

FIG. 8 illustrates representative SEM images of coatings resulting from microwave drying (using a constant frequency microwave furnace) of fibers within fiber papers dipped in the 10 wt % alumina suspension. The thickness of the coating deposited on the fibers shown in FIG. 8 (b) is about 500 nm.

Energy dispersive X-ray spectroscopy (EDX) revealed the cation content of the coated quartz-like fiber paper to be 31.01±1.41% Al and 68.99±1.41% Si.

### EXAMPLE 6

### Ceria Coated Quartz-like Fiber Paper

In this example, samples were prepared according to Example 1, except that a 10 wt % colloidal suspension of ceria (NYACOL) was used to produce CeO₂ coated quartz-like fiber paper.

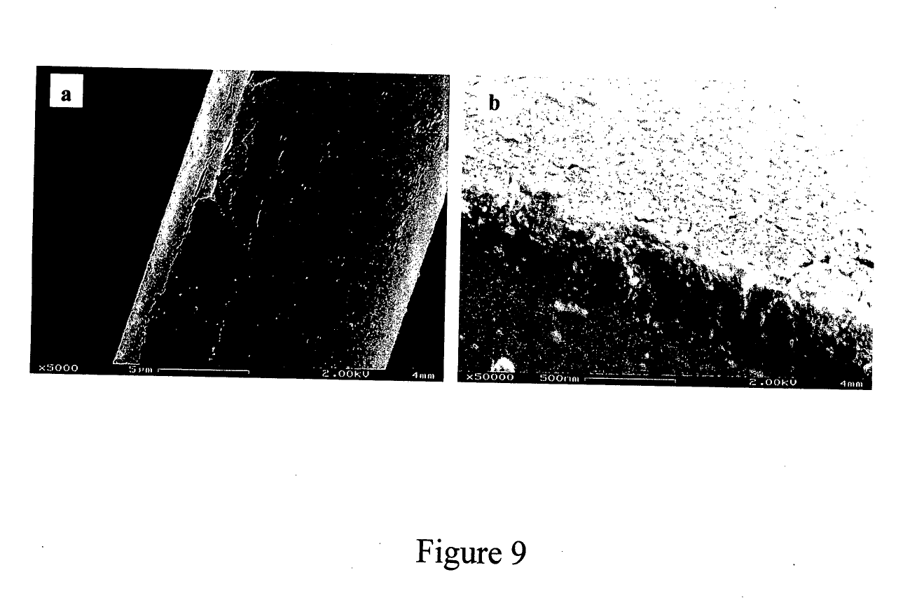

FIG. 9 illustrates representative SEM images of coatings resulting from microwave drying (using a constant frequency microwave furnace) of fiber papers dipped in the 10 wt % ceria suspension. The thickness of the coating deposited on the fibers shown in FIG. 9 (b) is about 400 nm.

EDX revealed the cation content of the coated quartz-like fiber paper to be 58.74±1.82% Ce and 41.26±1.82% Si.

### EXAMPLE 7

### Zirconia Coated Quartz-like Fiber Paper

In this example, samples were prepared according to Example 1, except that a 10 wt % colloidal suspension of zirconia (NYACOL) was used to produce ZrO₂ coated quartz-like fiber paper.

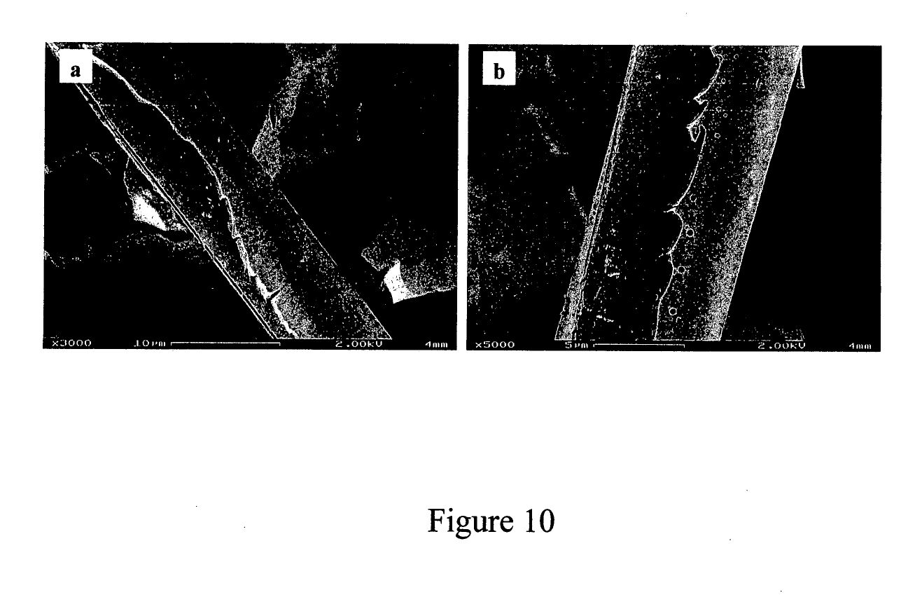

FIG. 10 illustrates representative SEM images of coatings resulting from microwave drying (using a constant frequency microwave furnace) fiber papers dipped in the 10 wt % zirconia suspension. The thickness of the coating deposited on the fibers shown in FIG. 10 (b) is about 310 nm.

EDX revealed the cation content of the coated quartz fiber paper to be 41.01±4.97% Zr and 58.99±4.97% Si.

### EXAMPLE 8

### Comparison Between Drying Methods for Activated Charcoal Coated on Quartz-like Fiber Paper

In this example, activated charcoal was coated on quartz-like fiber paper using a silica binder to facilitate coating. Three different drying methods were utilized so that the coating quality could be compared.

Samples were prepared according to Example 1, except that a slurry having 9.5 wt % activated charcoal and 0.5 wt % of colloidal silica (LUDOX) was used to produce the activated charcoal coated quartz-like fiber paper. Furthermore, instead of contacting the samples with tissue paper and/or glass to remove excess liquid, the samples were gently shaken.

The three drying methods included room temperature (i.e., about 23 to about 28° C.) evaporation of the carrier fluid for about 48 hours in a hood, heating in a convection furnace for about 50 minutes at about 120° C., and microwave heating for about 30 minutes at about 120° C. The samples dried in the hood were suspended using polyester fishing line. A watch glass was employed to hold the samples inside the convection furnace. Finally, polyester fishing line was used to hold the samples vertically, and to prevent the samples from moving, while being suspended over a non-microwave absorbent tray within the microwave furnace.

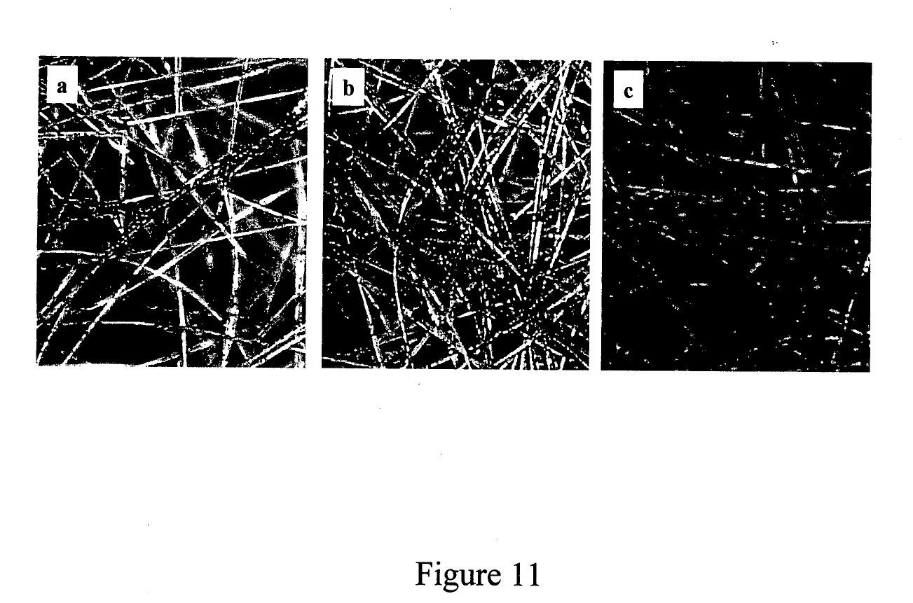

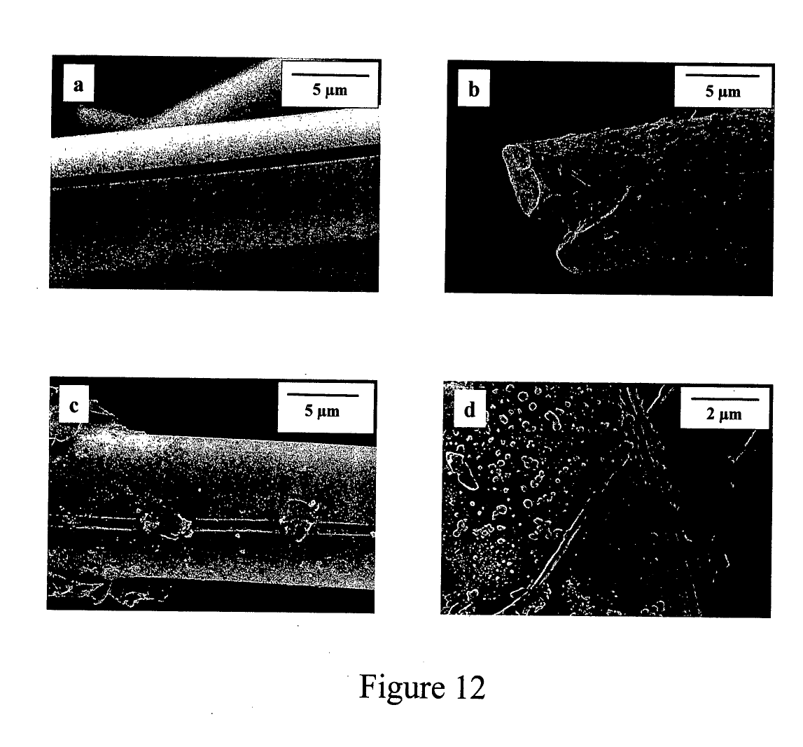

FIG. 11 illustrates representative optical images of the (a) room temperature dried, (b) convection heated, and (c) microwave heated coatings. Furthermore, FIG. 12 illustrates representative field emission SEM images of (a) an uncoated quartz-like fiber within a non-woven paper, and a (b) room temperature dried; (c) convection heated, and (d) microwave heated fiber, within a non-woven paper, of the coating. From FIGS. 11 and 12, it is apparent that the microwave heated samples exhibited a more uniformly distributed coating of the activated charcoal than did the non-microwave heated samples.

The coatings produced by microwave heating were more stable than the other two types of coatings, as evidenced by the flaking of a fine black powder from the other two samples after the drying step. Therefore, it is believed that the microwave heating may have facilitated the binding of the activated charcoal to the quartz-like fibers via the silica acting as a binder within the suspension.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for coating articles, the method comprising:
contacting a substrate with a mixture comprising a coating composition and a carrier fluid effective to wet at least a portion of the substrate; and
removing the carrier fluid by microwave heating for a time and at a temperature effective to produce a coating comprising the coating composition on the at least the portion of substrate.

2. The method of claim 1, wherein the contacting comprises dipping the substrate in the mixture, spraying the substrate with the mixture, brushing the substrate with the mixture, pouring the mixture on the substrate, paste casting the mixture on the substrate, inkjetting the mixture towards the substrate, flowing the mixture over the substrate in a fluid bed chamber, flowing the mixture over the substrate in an expanded bed chamber, or a combination comprising at least one of the foregoing.

3. The method of claim 1, further comprising removing any excess carrier fluid prior to the microwave heating.

4. The method of claim 3, wherein the removing any excess carrier fluid prior to the microwave heating comprises allowing gravity to act on the carrier fluid, agitating the wetted substrate, flowing a gas over the wetted substrate, contacting the wetted substrate with an adsorbent material, or a combination comprising at least one of the foregoing.

5. The method of claim 1, further comprising altering the microstructure of the coating.

6. The method of claim 5, wherein the altering the microstructure of the coating comprises sintering, annealing, or calcining the coating.

7. The method of claim 1, wherein a thickness of the coating is about 10 nanometers to about 1 millimeter.

8. The method of claim 1, wherein the coating has a less than or equal to about 10 percent deviation in thickness.

9. The method of claim 1, further comprising depositing an additional coating on the coating comprising the coating composition, wherein the additional coating has a same or a different composition as the coating composition.

10. The method of claim 1, wherein the microwave heating occurs for about 1 minute to about 6 hours.

11. The method of claim 1, wherein the microwave heating occurs at about 30 degrees Celsius to about 600 degrees Celsius.

12. The method of claim 1, wherein a frequency of the microwave heating is about 1 gigaHertz to about 7 gigaHertz.

13. The method of claim 1, wherein the removing the carrier fluid by microwave heating further comprises thermal heating.

14. The method of claim 1, wherein the coating composition comprises a metal, alloy, oxide, carbide, form of carbon, nitride, boride, a composite comprising at least one of the foregoing, or a combination comprising at least one of the foregoing.

15. The method of claim 1, wherein the removing the carrier fluid by microwave heating comprises microwave heating in a fluid bed chamber or an expanded bed chamber while flowing a gas in the fluid bed chamber or the expanded bed chamber.

16. The method of claim 1, wherein the carrier fluid comprises deionized water, distilled water, deionized and distilled water, nitric acid, acetic acid, sulfuric acid, phosphoric acid, hydrofluoric acid, a hydroxide of Na, K, or NH₄, an alcohol, a polyol, a ketone, or a combination comprising at least one of the foregoing carrier fluids.

17. The method of claim 1, wherein the substrate comprises a metal, alloy, ceramic, glass, polymer, fluorinated polymer, quartz, sapphire, wood, paper, carbon, or a combination comprising at least one of the foregoing.

18. A coated article produced by the method of claim 1.

19. A method of coating articles, the method comprising:
contacting a three-dimensional network of fibers with a mixture comprising a coating composition and a carrier fluid effective to wet at least a portion of the fibers,
removing the carrier fluid by microwave heating for a time and at a temperature effective to produce a coating comprising the coating composition on the at least the portion of fibers.

20. The method of claim 19, wherein the contacting comprises dipping the fibers in the mixture, spraying the fibers with the mixture, brushing the fibers with the mixture, pouring the mixture on the fibers, inkjetting the mixture on the fibers, paste casting the mixture on the fibers, flowing the mixture through the fibers in a fluid bed chamber, flowing the mixture through the fibers in an expanded bed chamber, or a combination comprising at least one of the foregoing.

21. The method of claim 19, further comprising allowing gravity to act on the carrier fluid, agitating the wetted substrate, flowing a gas over the wetted substrate, contacting the wetted substrate with an adsorbent material, or a combination comprising at least one of the foregoing, effective to remove any excess carrier fluid from the fibers prior to the microwave heating.

22. The method of claim 19, further comprising sintering, annealing, or calcining the coating.

23. The method of claim 19, wherein a thickness of the coating is about 10 nanometers to about 1 millimeter.

24. The method of claim 19, further comprising producing an additional coating composition on the coating, wherein the additional coating has a same or a different composition as the coating composition.

25. The method of claim 19, wherein the removing the carrier fluid by microwave heating comprises microwave heating in a fluid bed chamber or an expanded bed chamber while flowing a gas in the fluid bed chamber or the expanded bed chamber.

26. The method of claim 19, wherein the three-dimensional network of fibers comprise form a non-woven paper.

27. The method of claim 19, wherein the fibers of the three-dimensional network of fibers have an average diameter of about 5 micrometers to about 15 micrometers, and an average basis weight of about 18 grams per square meter to about 300 grams per square meter.

28. The method of claim 19, wherein the three-dimensional network of fibers comprise silica fibers, silica-like fibers, carbon fibers, or a combination comprising at least one of the foregoing.

29. A coated three-dimensional network of fibers produced by the method of claim 19.
